(19) United States
(12) Patent Application Publication
(10) Pub. No.: US 2008/0252936 A1
(43) Pub. Date: Oct. 16, 2008

(54) Personal network scanning profiles

(75) Inventor: Allan Stratton, Wakefield, MA (US)

Correspondence Address: BROMBERG & SUNSTEIN LLP, 125 SUMMER STREET, BOSTON, MA, 02110-1618, US

(73) Assignee: NUANCE COMMUNICATIONS, INC., Burlington, MA (US)

(21) Appl. No.: 12/103,720

(22) Filed: Apr. 16, 2008

Related U.S. Application Data
(60) Provisional application No. 60/912,004, filed on Apr. 16, 2007.

(51) Int. Cl. H04N 1/00

(52) U.S. Cl. 358/403

(57) ABSTRACT

User-specific scanning of documents on a computer network is described. A user profile containing a set of user-specific scanning settings associated with pre-identified scanning preferences of a specific user is retrieved from a network storage device. A paper document is scanned on a network scanning device based on the user profile to produce a representative scanned document, which is automatically forwarded to a network location associated with the user profile.

This application claims priority from U.S. Provisional Patent Application 60/912,004, filed Apr. 16, 2007, which is hereby incorporated herein by reference.

### FIELD OF THE INVENTION

The present invention relates to providing personalized functionality for scanning documents into multi-user computer network environments.

### BACKGROUND ART

Network scanning capabilities have become widespread with networked scan-enabled multifunction devices available in many office environments. These scan-enabled Multi-Function Peripherals (MFPs) look like the copiers of old, but have evolved into digital multi-function devices that provide copy, scan, fax, and print capabilities. Using these machines for copying, faxing, and printing is straightforward, but it is usually not straightforward to use them for scanning. Scanning from these devices often requires many setup and administration steps that are not easy, or sometimes, not even possible for a typical user to perform. Scan-to-e-mail has been offered as an easier way to provide scanning functionality for end users, but this has several drawbacks, including:
the need to tediously input e-mail addresses using a soft keypad on the device,
the need to perform additional manual steps at the desktop after the e-mail has arrived in order to transfer the document to its final location, and
the possibility that corporate e-mail systems will not allow large documents to be transferred in this way.

Scanning from an MFP using the built-in scanning features usually also requires the user to perform additional manual steps once the scan has completed and the document has been transferred to the selected destination. In most cases, a document initially is scanned so that it then can be further processed by one or more users or by additional software. When a user scans a document from an MFP, they will often return to their desktop work station to retrieve the scanned document and then manually start the next steps that need to be performed with the document.

The network scanning process can become very time-consuming, especially for users who do not use the MFP's scanning features on a regular basis. The small number of users in an organization who need to scan documents every day or even every week will usually have no trouble remembering the steps they need to follow. However, when someone has only an occasional need for scanning, they will often find it difficult to remember where the documents are scanned to, and they may even find that they are not set-up to scan from the device at all. These users will also have a much harder time figuring out where the scanned documents went if they do not arrive in the location that was expected.

A class of desktop work station applications has been created which ease some of the problems associated with network scanning from an MFP. These applications look for documents scanned from an MFP that arrive in a user's e-mail inbox and/or a network location used as a scanned documents repository. A user or administrator configures the application to monitor the pre-established locations, and when new documents arrive, the software can perform one or more responsive actions based on the user's preferences; for example, to launch the newly scanned document in an application that the user commonly uses to manipulate scanned documents.

One issue with this type of solution is that it requires the user to know what network scanning location will be used when scanning from the MFP, and/or it requires an administrator to participate in setting up the connection. This connection can be easily broken if the MFP is updated to scan to a different location. Another issue is that the scanned documents retrieved by this type of solution can typically only be transferred to one particular configured location on the user's desktop work station or on the network. This means that if the user scans many different types of documents that all need to be stored in different locations, then additional manual copying will be required. Finally, these applications typically do not offer an intuitive way for the user to specify that additional automatic processing and/or document conversion should be performed once the document arrives at the user's desktop work station.

Another solution for network scanning from an MFP is provided by a variety of so-called middleware systems that help make network scanning from an MFP more manageable. These systems typically allow an administrator to configure some number of defined scanning workflows that will be available to users of the MFPs in an organization. Some applications allow these workflows to be very flexible, for example, a workflow editor might be provided that allows an organization to pre-define the output file type that will be selected for scanning from the MFP as well as one or more destinations where the file can be sent once it is scanned. The destinations will typically include options such as e-mail and one or more Document Management Systems. It is common in middleware systems for the software to come with some partially pre-configured workflow options (e.g. “Scan to Document Management System”) where the administrator will then enter a path to the document management system and perhaps login credentials to use with that system before the workflow can be used by any users in the organization. Other solutions are more rigid and only provide a small number of pre-configured workflows or “scan-to” destinations that can only be minimally configured after installation by an administrator.

Middleware systems provide a “one size fits all” solution for scanning in the enterprise. The systems make it possible for a small number of people in an organization to perform the kinds of scanning tasks that they need to execute on a regular basis. For example, one or two people in a finance department may need to scan new invoices once per day and upload those to the document management system used by that department. This task could be accomplished using one of the existing middleware solutions, provided that the proper workflow had been set up by an administrator beforehand. But, these solutions do not typically offer an easy way for casual users to take advantage of the network scanning capabilities of MFPs. Middleware systems provide only a few workflows for directed tasks, and do not offer a flexible option for ad-hoc scanning. Some of the middleware systems do provide the ability for power-users to create new workflows that they can customize to their tasks, but again, these workflows would be used for very common scanning tasks and need to be set up in advance, which precludes their use for ad-hoc scanning.

Middleware systems also often offer a number of document conversion options that can convert the scanned files (most often TIFF or Image-Only PDF formats) into several available output formats. Possible format options from the middleware systems might include image formats not directly supported by the MFP and also text formats (via OCR), such as Microsoft Word and text-based PDF formats. The advantage is that many additional formats can be provided that are not traditionally supported directly by the MFP. The disadvantages include the lack of an integrated proof-reading capability to correct errors from the OCR process and a very limited set of options for controlling the conversion process. This latter limitation is partly due to the need to have a relatively small number of format output options to serve a large user community.

### SUMMARY OF THE INVENTION

Embodiments of the present invention are directed to user-specific scanning of documents on a computer network. A user profile containing a set of user-specific scanning settings associated with pre-identified scanning preferences of a specific user is retrieved from a network storage device. A paper document is scanned on a network scanning device based on the user profile to produce a representative scanned document, which is automatically forwarded to a network location associated with the user profile.

Further embodiments are directed to creating the user profile, and storing it in the network storage device. The user profile may be loaded into the network scanning device or a settings storage component in communication with the network scanning device. Scanning the paper document may include creating editable text for the scanned document and/or extracting indexing terms to be associated with the scanned document.

In further specific embodiments, automatically forwarding the scanned document may include providing document parsing instructions for the network location to execute on the scanned document. In such embodiments, scanning a paper document may include generating the parsing instructions. Embodiments may then parse the scanned document at the network location according to the parsing instructions. For example, parsing the scanned document may include performing text recognition of the scanned document; and prompting the user for proofreading of the text recognition results.

### BRIEF DESCRIPTION OF THE DRAWINGS

FIG. 1 shows a basic computer network containing a multi-function peripheral (MFP) for use with user scanning profiles according to an embodiment of the present invention.

FIG. 2 illustrates various functional steps in scanning documents according to an embodiment of the present invention.

### DETAILED DESCRIPTION OF SPECIFIC DRAWINGS

There is a need to take into account the needs of a larger group of users who could better exploit the advantages of scanning from network MFPs, and avoid the limitations of previous solutions. Embodiments of the present invention provide a method for end users to easily scan directly to the locations and formats that are most useful for them.

Embodiments of the present invention take advantage of software on a user's desktop work station that is able to detect incoming scanned documents that have come from a network scanning device. These instructions are produced and transmitted via existing methods in the support software provided by MFP manufacturers. The document processing instructions specify what options the user chose at the MFP control panel at scan time. When a newly scanned document arrives at a location known by an embodiment of the software, the software reads the instructions to determine how the scanned document should be processed. This can include instructions to store the document in one or more locations on the user's local work station or on the network, conversion to one or more formats (optionally using OCR), image processing on the document (e.g. to automatically straighten the document, or to automatically rotate the image if it was scanned upside down or rotated to the left or right), and execution of document processing workflows on the user's work station.

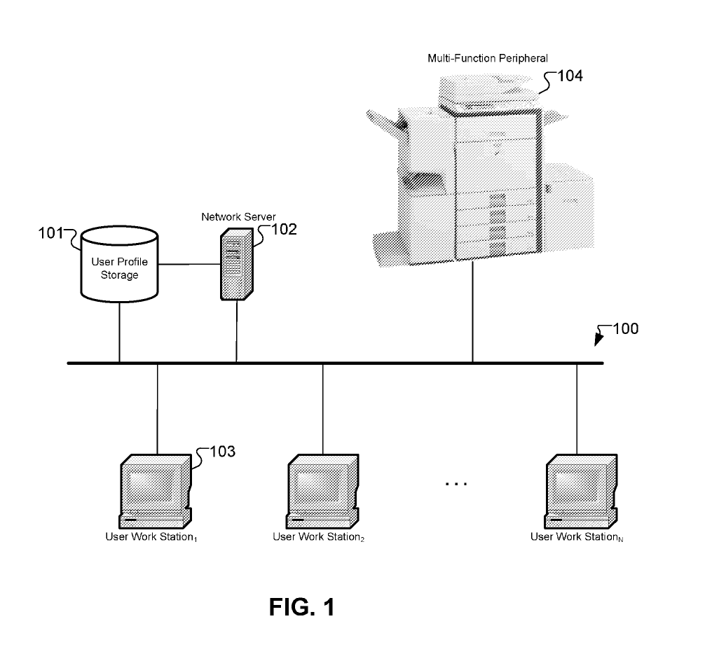

FIG. 1 shows a basic computer network containing a multi-function peripheral (MFP) for use with user scanning profiles according to an embodiment of the present invention. Digital multi-functional peripheral (MFP) 104 is a device on computer network 100 which provides multiple document processing functions such as, for example, copying, scanning, faxing, and printing. Also on the network 100 are various user work stations 103 which among other things may be used to input a user-specific scanning setting for a given user profile. The user scanning profiles may be stored either on the work stations 103 themselves, or in a convenient network storage component such as the user profile storage database 101 on FIG. 1.

A network server 102 may oversee and coordinate use of the MFP 104 and the user scanning profiles. The network server 102 stores personalized settings for each user who has registered their scanning options and mediates communications between client work stations and network MFPs. The network server 102 provides an interface to present those options for selection by the user when they are using a given MFP 104. These options may be presented using an interface framework provided by the MFP vendor. The network server 102 may also tell the software on the client work stations 103 where to expect scanned documents to arrive and it may tell the MFP 104 where to scan to for the given user. The software on the network server 102 may also generate the instructions that are passed along with the scanned document to the software on the client work station 103.

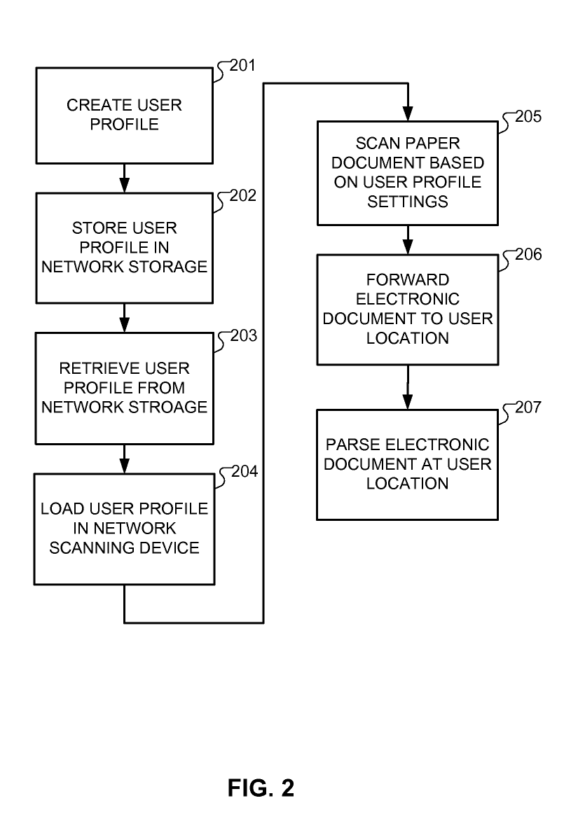

FIG. 2 illustrates some of the logical steps in scanning a document based on user scanning profiles according to an embodiment of the present invention. First, each user creates a user scanning profile, step 201. A software component on the client work stations allows each user to specify the options they want to be able to select from at scan time. This software component presents the user with folder choices, document conversion workflow choices, and options for selecting collections of scan-time settings to use to direct the scan process on the MFP. There is no theoretical limit on the number of options a user could choose from each of these categories. However, the display size of the MFP control panel and decisions about what user interface components are selected to display these options to the user at the MFP may impose practical limits on how many choices the user should enable. Once the user has completed their selections in this software component, the options will be available for scanning at the networked MFP any time they want to scan a document.

The user profile is stored in network storage, step 202. The user may be able to update their settings at any time, without requiring support from the IT department or another machine administrator. If they want to add or remove folders, for example, if they have added some new folders for documents on their work station, they can simply use the same client software.

Once the user scanning profile has been stored on the network, when a user wants to scan a document on a network MFP, the user scanning profile is retrieved from network storage, step 203, and the document is scanned based on the profile settings, step 205, to create an electronic scanned document. Scanning the paper document may include creating editable text for the scanned document and/or extracting indexing terms to be associated with the scanned document.

The scanned document is then forwarded to the network location associated with the user in the user scanner profile, step 206. Along with the scanned document, embodiments of the present invention provide additional parsing instructions based on the user settings in the user scanning profile which define additional parsing and processing to be performed by the software component at the receiving work station. This may include converting the scanned document to an editable form (e.g., via OCR), combining the scanned document with one or more other existing scanned documents on the user's desktop work station or elsewhere on the network, or using OCR to extract indexing terms from the scanned document for identification and retrieval when a text-based search is performed later, in addition to many other tasks that may commonly be performed with documents after they are scanned.

The work station that receives the scanned document may further parse and process the scanned document based on the settings in the user scanning profile, step 207. The software is able to parse the instructions that are sent along with those scanned documents and is able to execute those instructions to complete the initial processing of the received scanned document. For example, in some embodiments, the OCR workflows allow for the user at the work station to be automatically prompted for proofreading of the documents during the OCR process.

For users who also have a desktop scanner, some embodiments may allow them to take advantage of their current scanning tasks when utilizing a network MFP. For example, a user in the legal department may use a desktop scanner to scan incoming contracts in searchable PDF format and store them in a folder shared by other members of the legal department. This process may be conveniently performed most times by using a desktop scanner, but the same process could easily be adapted to use with a network MFP if a large number of contracts came in on a particular day, for example, if the network MFP has a much faster scanning capability and/or larger document feeder compared to the desktop scanner.

The adaptation of the desktop process for use with the MFP may be completely automatic, requiring only that the user make the settings used in the desktop process available at the MFP using the software component referenced earlier for choosing settings for MFP scanning. This allows for a networked MFP to scan a document “directly” to a folder on the user's desktop work station. And a user can specify any number of folders on either their own desktop work station or anywhere else on the network that is accessible from their desktop work station. This is different from previous systems which sometimes allow users to scan directly to just a few folders that are shared on the network and directly accessible to the MFP or middleware software. Thus, in such prior art systems, users could only scan to a small number of folders and users were limited to scanning to the same folders or to subfolders in the same tree.

Embodiments of the invention may be implemented in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or scanned documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method for user-specific scanning of documents on a computer network, the method comprising:
retrieving from a network storage device a user profile containing a set of user-specific scanning settings associated with pre-identified scanning preferences of a specific user;
scanning a paper document on a network scanning device based on the user profile to produce a representative scanned document; and
automatically forwarding the scanned document to a network location associated with the user profile.

2. A method according to claim 1, further comprising:
creating the user profile; and
storing the user profile in the network storage device.

3. A method according to claim 1, further comprising:
loading the user profile into the network scanning device.

4. A method according to claim 1, further comprising:
loading the user profile into a settings storage component in communication with the network scanning device.

5. A method according to claim 1, wherein scanning the paper document includes creating editable text for the scanned document.

6. A method according to claim 1, wherein scanning the paper document includes extracting indexing terms to be associated with the scanned document.

7. A method according to claim 1, wherein automatically forwarding the scanned document includes providing document parsing instructions for the network location to execute on the scanned document.

8. A method according to claim 7, wherein scanning a paper document includes generating the parsing instructions.

9. A method according to claim 7, further comprising:
parsing the scanned document at the network location according to the parsing instructions.

10. A method according to claim 9, wherein parsing the scanned document includes
performing text recognition of the scanned document; and
prompting the user for proofreading of the text recognition results.

11. A method according to claim 7, wherein the parsing instructions include document workflow processing instructions for further handling of the scanned document.

12. An interface for user-specific scanning of documents on a computer network, the interface comprising:
means for retrieving from a network storage device a user profile containing a set of user-specific scanning settings associated with pre-identified scanning preferences of a specific user;
means for scanning a paper document on a network scanning device based on the user profile to produce a representative scanned document; and
means for automatically forwarding the scanned document to a network location associated with the user profile.

13. An interface according to claim 12, further comprising:
means for creating the user profile; and
means for storing the user profile in the network storage device.

14. An interface according to claim 12, further comprising:
means for loading the user profile into the network scanning device.

15. An interface according to claim 12, further comprising:
means for loading the user profile into a settings storage component in communication with the network scanning device.

16. An interface according to claim 12, wherein the means for scanning the paper document includes means for creating editable text for the scanned document.

17. An interface according to claim 12, wherein the means for scanning the paper document includes means for extracting indexing terms to be associated with the scanned document.

18. An interface according to claim 12, wherein the means for automatically forwarding the scanned document includes providing document parsing instructions for the network location to execute on the scanned document.

19. An interface according to claim 18, wherein the means for scanning a paper document includes generating the parsing instructions.

20. An interface according to claim 18, further comprising:
means for parsing the scanned document at the network location according to the parsing instructions.

21. An interface according to claim 20, wherein the means for parsing includes means for performing text recognition of the scanned document; and means for prompting the user for proofreading of the text recognition results.

22. An interface according to claim 18, wherein the means for parsing instructions include document workflow processing instructions for further handling of the scanned document.

23. A method for parsing a scanned document on a client work station, the method comprising:
automatically parsing a scanned document on the workstation . . . .
